(19) United States
(12) Patent Application Publication
(10) Pub. No.: US 2024/0204226 A1
(43) Pub. Date: Jun. 20, 2024

(54) MEMBRANE ELECTRODE ASSEMBLY MANUFACTURING PROCESS

(71) Applicants: W. L. Gore & Associates GmbH, Putzbrunn (DE); W. L. Gore & Associates G.K., Tokyo (JP)

(72) Inventors: Amr Mahmoud Hamdy Kobaisy Ali, Putzbrunn (DE); Akinari Kurokawa, Tokyo (JP); Masashi Maruyama, Tokyo (JP); Masaki Tani, Tokyo (JP)

(21) Appl. No.: 18/541,690

(22) Filed: Dec. 15, 2023

Related U.S. Application Data
(60) Provisional application No. 63/387,511, filed on Dec. 15, 2022.

(51) Int. Cl. H01M 8/1004

(52) U.S. Cl. CPC H01M 8/1004; H01M 2008/1095

(57) ABSTRACT

The present invention relates to a method of making a fuel cell component, the method comprising:
providing a substrate with a first side and a second side;
forming an electrode on the first side of the substrate, wherein the forming includes depositing a coating composition on the first side of the substrate;
applying a support layer onto the electrode formed on the first side of the substrate;
inverting the substrate to make the second side of the substrate available for forming an electrode thereon;
forming an electrode on the second side of the substrate wherein the forming includes depositing a coating composition on the second side of the substrate.

Preferably, the substrate comprises a releasable backing layer on the second side of the substrate, and the method includes the step of (vi) removing the backing layer so as to expose the second side of the substrate to make the second side of the substrate available for forming an electrode thereon.

### CROSS-REFERENCE TO RELATED APPLICATION

This application claims the benefit of Provisional Application No. 63/387,511, filed Dec. 15, 2022, which is incorporated herein by reference in its entirety for all purposes.

### FIELD OF THE INVENTION

The present disclosure relates to membrane electrode assemblies for polymer electrolyte membrane (PEM) fuel cells, and in particular, to a method of making a component of a membrane electrode assembly (MEA) that includes depositing a coating composition comprising a catalyst, and an ionomer on a substrate to form an electrode.

### BACKGROUND OF THE INVENTION

A membrane electrode assembly (MEA) is a core component of a polymer electrolyte membrane (PEM) Fuel Cell. A membrane electrode assembly (MEA) is comprised of a polymer electrolyte membrane (PEM) with an anode electrode on one side of the PEM and a cathode electrode on the other side of the PEM. Thus, the final MEA may comprise a three-layer assembly, including an anode layer, a PEM layer and a cathode layer. Additionally, the MEA may also include Gas Diffusion Layers (GDLs), which are typically comprised of carbon paper, and are attached to the outer surface of each electrode. If GDLs are attached to both electrodes then the final MEA is considered a five-layer assembly including a first layer of GDL, an anode layer, a PEM layer, a cathode layer and another layer of GDL. Typically, the PEM and GDLs have sufficient mechanical integrity to be self-supporting webs, but the electrodes do not have the sufficient mechanical integrity. Therefore each electrode is typically formed on a substrate which may be the PEM, a GDL, or a release layer. The layers of the MEA are then bonded together with heat and/or pressure as needed to form a composite sheet.

There are various established techniques for forming the electrodes on a substrate and/or bonding the electrodes to other layers of the MEA; however, each technique has problems. Traditionally, the electrodes were coated onto a release layer and then laminated to a PEM (Decal Process). However, this method is inefficient and costly. More recently, this process has been streamlined by coating the electrodes directly onto the PEM. Direct coating can enable low cost and high-volume production. Techniques for direct coating include slot die, screen printing or spray coating. The direct coating process can be performed continuously or discontinuously. However, coating the electrode directly on the PEM can result in distorting or dissolving of the PEM, which can be particularly problematic when a thinner PEM is used. Distortions in the PEM can also lead to damage in the electrode layer. Reference to thinner is to be understood to refer to a PEM with a thickness of less than 30 microns, and may be lower than 25 microns, and may be lower than 20 microns and may even be lower than 15 microns.

Thin polymer electrolyte membranes (PEM) can be challenging to directly coat electrodes on both sides of the PEM while ensuring stability of the web and enabling good quality coating. In particular, wrinkles in the electrode layers can appear after the coating of thin polymer electrolyte membranes.

Accordingly, the need exists for improved methods of manufacturing components for membrane electrode assemblies in an efficient, high quality and cost effective manner.

### SUMMARY OF THE INVENTION

In one embodiment, the present disclosure relates to a method of making a fuel cell component, the method comprising
a. providing a substrate with a first side and a second side;
b. forming a first electrode on the first side of the substrate, wherein the forming includes depositing a first coating composition on the first side of the substrate;
c. applying a support layer onto the first electrode formed on the first side of the substrate;
d. inverting the substrate to make the second side of the substrate available for forming a second electrode thereon;
e. forming the second electrode on the second side of the substrate wherein the forming includes depositing a second coating composition on the second side of the substrate.

In another embodiment, the substrate comprises a releasable backing layer on the second side of the substrate, and wherein step (d.) of the above method includes removing the backing layer so as to expose the second side of the substrate to make the second side of the substrate available for forming the second electrode thereon.

In another embodiment, the depositing of the first and second coating composition on the first and second side of the substrate includes a coating process using a slot die.

In one embodiment, the coating process may be carried out using a continuous process. In another embodiment, the coating process may be carried out using a discontinuous process.

In another embodiment, the coating composition is deposited on to the substrate either continuously or intermittently, to form the first and second electrodes on the first and second sides of the substrate, respectively.

In other embodiments, the forming of the first electrode in step b. includes a step of drying the coated first side of the substrate. In another embodiment, the step of drying is carried out before the step of applying the support layer.

In other embodiments, the forming of the second electrode in step e. includes a step of drying the coated second side of the substrate.

In another embodiment, the electrode may be a cathode or anode.

In one embodiment, the electrode on the first side of the substrate forms a cathode; and the electrode on the second side of the substrate forms an anode.

According to this disclosure a support layer is applied to the first electrode of the substrate. In an embodiment the support layer is applied after the substrate and the first electrode layer have passed a drying step.

The support layer protects the surface of the first electrode layer and provides support and stability to the composite of substrate and first electrode layer for subsequent process steps.

In the embodiment, where the substrate comprises a thickness of below 30 microns, the support layer provides stability to the composite for the subsequent second direct coating step to attach the second electrode to the substrate.

In one embodiment the support layer comprises a single layer or film, formed of a plastics material, for example, a polyethersulfone (PES), polyethylene terephthalate (PET), Polyethylene (PE) or polyolefin. The support layer may comprise a porous or a non-porous layer. The support layer can be a film, fabric (woven/unwoven) and such like.

Preferably, the support layer comprises a polyethylene terephthalate (PET) film. In other embodiments, the support layer may comprise a gas diffusion layer.

In embodiments, the support layer is applied to the first electrode by a hot roll lamination process.

In another embodiment, the support layer has a thickness of lower than 250 microns, lower than 200 microns, lower than 150 microns, lower than 100 microns, lower than 50 microns.

In another embodiment, the support layer may be releasable.

In another embodiment, the first and/or the second coating composition comprises a catalyst and an ionomer.

In another embodiment, the first and second coating composition are the same or different and each independently comprises a supported catalyst, an ionomer and one or more solvents.

In another embodiment, the catalyst comprises a noble metal, a transition metal, or an alloy thereof.

In another embodiment, the ionomer is a proton-conducting polymer.

In another embodiment, the proton-conducting polymer comprises perfluorosulfonic acid.

In another embodiment, the first coating composition comprising a solution or dispersion comprising at least 10 wt % of catalyst and ionomer for forming the cathode.

In another embodiment, the second coating composition comprising a solution comprising at least 10 wt % of catalyst and ionomer for forming the anode.

In some embodiments, the substrate comprises a porous layer, a non-porous layer or a combination thereof.

In another embodiment, the substrate may comprises a polymer electrolyte membrane (PEM), which may comprise a proton-conducting polymer or ion exchange material. The polymer electrolyte membrane may comprise at least one porous layer comprising a microporous polymer structure and an ion exchange material at least partially embedded within the microporous polymer structure and rendering the microporous polymer structure occlusive.

The polymer electrolyte membrane may comprise a porous microstructure and an ion exchange material (ionomer or proton-conducting polymer) impregnated in the porous microstructure. The porous microstructure may comprise a perfluorinated porous polymeric material, e.g., an ePTFE membrane. In another aspect, the porous microstructure comprises a hydrocarbon material, optionally polyethylene, polypropylene, or polystyrene.

In one embodiment, the fuel cell component is a membrane electrolyte assembly (MEA). In another embodiment, the fuel cell component is a catalyst coated membrane (CCM). The catalyst coated membrane may comprise a two-side catalyst coating.

### BRIEF DESCRIPTION OF THE DRAWINGS

The present invention will be better understood in view of the following non-limiting figures, in which:

FIG. 1(a) shows a first stage of a method according to this disclosure; and

FIG. 1(b) is a schematic cross-sectional view taken along the line AA of FIG. 1a;

FIG. 2(a) shows a second stage of a method according to this disclosure;

FIG. 2(b) is a schematic cross-sectional view taken along the line BB of FIG. 2a;

FIG. 3(a) is a graph which shows example properties of a first coating composition (cathode ink);

FIG. 3(b) is a graph which shows example properties of a second coating composition (anode ink);

FIG. 3(c) is a graph which shows example properties of another second coating composition (anode ink); and

FIGS. 4(a)-4(d) show surface photographs of MEA's manufactured according to a method of this disclosure.

### DETAILED DESCRIPTION OF THE INVENTION

### I. Introduction

Persons skilled in the art will readily appreciate that various aspects of the present disclosure can be realized by any number of methods and apparatus configured to perform the intended functions. It should also be noted that the accompanying figures referred to herein are not necessarily drawn to scale, and may be exaggerated to illustrate various aspects of the present disclosure, and in that regard, the figures should not be construed as limiting. Directional references such as “up,” “down,” “top,” “left,” “right,” “front,” and “back,” among others are intended to refer to the orientation as illustrated and described in the figure (or figures) to which the components and directions are referencing. It is to be noted that all ranges described herein are exemplary in nature and include any and all values in between. In addition, all references cited herein are incorporated by reference in their entireties.

A membrane electrode assembly (MEA) is comprised of a polymer electrolyte membrane (PEM) with an anode electrode on one side and a cathode electrode on the other side. The final MEA may be a three-layer assembly, having the layers placed adjacent to each other as Anode-PEM-Cathode in the final MEA. The three-layer assembly may also be referred to as a catalyst coated membrane (CCM). Additionally, the MEA may also include Gas Diffusion Layers (GDLs) attached to the outer surface of each electrode. If GDLs are attached to both electrodes then the final MEA is considered a five-layer assembly, having the layers placed adjacent to each other as GDL-Anode-PEM-Cathode-GDL in the final MEA. According to various embodiments, the layers may be formed in any order, for example the PEM may be formed before the GDLs, the anode, or the cathode.

The invention seeks to improve defects with known direct coating methods for forming electrodes on a substrate such as a PEM. In particular, the invention provides a technical solution to the problem of direct coating of thin substrates. Coating the electrode directly on the PEM can result in distorting or dissolving of the PEM, which can be particularly problematic when a thinner PEM is used. Distortions in the PEM can also lead to damage in the electrode layer. Thin polymer electrolyte membranes can be challenging to coat without additional support. When directly coating both sides of the PEM there is a need for an intermediate support layer lamination step after the first side of the PEM is coated, to ensure stability of the web and enabling good quality coating on the second side of the PEM.

In one embodiment, the method of the disclosure describes directly coating (continuously or intermittently) a cathode layer first on a PEM. The PEM may comprise a backing layer opposite to the cathode layer. After drying the coated cathode layer a laminator attaches a support layer over the cathode coated side so as to cover the cathode electrode with the support layer on top. Specific lamination conditions are applied to ensure good level of adhesion of the support layer with the cathode layer. The following step would be to invert the PEM and remove the backing layer off the PEM and directly coat the anode layer (continuously or intermittently) on the opposite side of the cathode, leveraging the stability provided by the support layer. A drying step and a rewind step follow. The product is a two-sided catalyst coated membrane (CCM) or MEA. According to some embodiments, the CCM or MEA may be a three-layer assembly including an anode layer, a PEM layer and a cathode layer. In some embodiments, the MEA may further include gas diffusion layers (GDLs). In certain embodiments, the GDLs may include carbon paper. In some embodiments, the GDLs are attached to the outer surface of each electrode (i.e., the anode layer and the cathode layer).

The method according to this disclosure is a simplified process for 2-sided coating compared to the Decal process of the prior art. The method according to this disclosure will save cost and enable scale up of the production. Furthermore, the integration of a support layer in the coating process can provide high quality electrode layers. Composites of PEM and first electrode supported with a support layer can reduce complexity for further processing.

In one embodiment, the disclosure is directed to a method of making a component for a fuel cell, the method comprising providing a substrate and forming at least one electrode on the substrate. The forming includes depositing at least one coating composition on the substrate. The term depositing is intended to include but not be limited to various means of applying liquid coatings, such as slot die coating, slide die coating, curtain coating, gravure coating, reverse roll coating, spray coating, knife-over-roll coating, and dip coating. The term liquid is intended to include electrode ink.

As used herein, the term “substrate” refers to a porous layer, a non-porous layer, or combinations thereof. In one embodiment, the substrate comprises a polymer electrolyte membrane (PEM). The polymer electrolyte membrane may comprise at least one porous layer comprising a microporous polymer structure and an ion exchange material at least partially embedded within the microporous polymer structure and rendering the microporous polymer structure occlusive.

In some embodiments, the ion exchange material may be fully embedded within the microporous polymer structure. The ion exchange material may include more than one ion exchange material in the form of a mixture of ion exchange materials.

In other embodiments, the ion exchange material may include more than one layer of ion exchange material. The layers of ion exchange material may be formed of the same ion exchange material. Alternatively, the layers of ion exchange material may be formed of different ion exchange materials. At least one of the layers of ion exchange material comprises a mixture of ion exchange materials. The ion exchange material may include at least one ionomer. The at least one ionomer may include a proton conducting polymer. The proton conducting polymer may include perfluorosulfonic acid.

In some embodiments, the microporous polymer structure has a first surface and a second surface. The ion exchange material may form a layer on the first surface, on the second surface, or both on the first surface and the second surface. According to various embodiments, the ion exchange material may be partially embedded within the microporous polymer structure leaving a non-occlusive portion of the microporous polymer structure closest to the first surface, second surface or both. The non-occlusive portion may be free of any of the ion exchange material. The non-occlusive portion may include a coating of ion exchange material to an internal surface of the microporous polymer structure.

The polymer electrolyte membrane may comprise a single porous layer. The polymer electrolyte membrane may comprise more than one porous layer. In embodiments in which the polymer electrolyte membrane comprises at least two porous layers, the composition of at least two porous layers may be the same, or it may be different.

The microporous polymer structure of the porous layer may comprise a fluorinated polymer. The fluorinated polymer may be selected from the group comprising: polytetrafluoroethylene (PTFE), poly(ethylene-co-tetrafluoroethylene) (EPTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) or mixtures thereof. The fluorinated polymer may be perfluorinated expanded polytetrafluoroethylene (ePTFE).

The polymer electrolyte membrane may include at least one backing layer attached to one or more external surfaces of the membrane. In some embodiments, the polymer electrolyte membrane may be released (or otherwise uncoupled) from the backing layer prior to being incorporated in a membrane electrode assembly (MEA).

Suitable backing layers may comprise woven materials which may include, for example, scrims made of woven fibers of expanded porous polytetrafluoroethylene; webs made of extruded or oriented polypropylene or polypropylene netting, commercially available from Conwed, Inc. of Minneapolis, Minn.; and woven materials of polypropylene and polyester, from Tetko Inc., of Briarcliff Manor, N.Y. Suitable non-woven materials for the backing layer may include, for example, a spun-bonded polypropylene from Reemay Inc. of Old Hickory, Tenn. In other aspects, the backing layer can include web of polyethylene (“PE”), polystyrene (“PS”), cyclic olefin copolymer (“COC”), cyclic olefin polymer (“COP”), fluorinated ethylene propylene (“FEP”), perfluoroalkoxy alkanes (“PFAs”), ethylene tetrafluoroethylene (“ETFE”), polyvinylidene fluoride (“PVDF”), polyetherimide (“PEI”), polysulfone (“PSU”), polyethersulfone (“PES”), polyphenylene oxide (“PPO”), polyphenyl ether (“PPE”), polymethylpentene (“PMP”), polyethyleneterephthalate (“PET”), or polycarbonate (“PC”). In some aspects, the backing layer also includes a protective layer, which can include polyethylene (PE), polystyrene (“PS”), cyclic olefin copolymer (“COC”), cyclic olefin polymer (“COP”), fluorinated ethylene propylene (“FEP”), perfluoroalkoxy alkanes (“PFAs”), ethylene tetrafluoroethylene (“ETFE”), polyvinylidene fluoride (“PVDF”), polyetherimide (“PEI”), polysulfone (“PSU”), polyethersulfone (“PES”), polyphenylene oxide (“PPO”), polyphenyl ether (“PPE”), polymethylpentene (“PMP”), polyethyleneterephthalate (“PET”), or polycarbonate (“PC”). In yet other aspects, backing layer optionally may include a reflective layer that includes a metal substrate (e.g., an aluminum substrate).

Preferably, the backing layer comprises a polymer sheet substrate (obtained from DAICEL VALUE COATING LTD., Japan) comprising PET and a protective layer of cyclic olefin copolymer (COC), and during the process, the backing layer is oriented with the COC side on top.

As used herein, the term “support layer” refers to a single layer or film that is attached to the first electrode of the substrate before the application of the second electrode.

Suitable support layers may comprise woven materials which may include, for example, scrims made of woven fibers of expanded porous polytetrafluoroethylene; webs made of extruded or oriented polypropylene or polypropylene netting, commercially available from Conwed, Inc. of Minneapolis, Minn.; and woven materials of polypropylene and polyester, from Tetko Inc., of Briarcliff Manor, N.Y. Suitable non-woven materials for the support layer may include, for example, a spun-bonded polypropylene from Reemay Inc. of Old Hickory, Tenn. In other aspects, the support layer can include web of polyethylene (“PE”), polystyrene (“PS”), cyclic olefin copolymer (“COC”), cyclic olefin polymer (“COP”), fluorinated ethylene propylene (“FEP”), perfluoroalkoxy alkanes (“PFAs”), ethylene tetrafluoroethylene (“ETFE”), polyvinylidene fluoride (“PVDF”), polyetherimide (“PEI”), polysulfone (“PSU”), polyethersulfone (“PES”), polyphenylene oxide (“PPO”), polyphenyl ether (“PPE”), polymethylpentene (“PMP”), polyethyleneterephthalate (“PET”), or polycarbonate (“PC”).

In one embodiment the support layer comprises a polyethylene terephthalate (“PET”) film.

In another embodiment, the support layer has a thickness of lower than 250 microns, lower than 200 microns, lower than 150 microns, lower than 100 microns, lower than 50 microns.

In embodiments, the polyethylene terephthalate (“PET”) film has a thickness of 50 microns.

In another embodiment the support layer may be releasable and can be detached from the first electrode.

In another embodiment, the support layer is applied to the first electrode after drying of the first coating composition for forming the first electrode on the first side of the substrate.

In another embodiment, the substrate is a polymer electrolyte membrane (PEM) and the first electrode forms a cathode on a first side of the polymer electrolyte membrane, whereby the support layer is applied onto the cathode.

In another embodiment, the support layer is laminated onto the first electrode. The lamination process comprises a heated roll pressing step. The heated roll may have a temperature of about 160° C. The lamination pressure may be between 0.35 Mpa/m and 0.50 Mpa/m, preferably at about 0.48 Mpa/m or at about 0.42 Mpa/m.

As used herein, the terms “ionomer” and “ion exchange material” refer to a cation exchange material, an anion exchange material, or an ion exchange material containing both cation and anion exchange capabilities. Mixtures of ion exchange materials may also be employed. Ion exchange material may be perfluorinated or hydrocarbon-based. Suitable ion exchange materials include, for example, perfluorosulfonic acid polymers, perfluorocarboxylic acid polymers, perfluorophosphonic acid polymers, styrenic ion exchange polymers, fluorostyrenic ion exchange polymers, polyarylether ketone ion exchange polymers, polysulfone ion exchange polymers, bis(fluoroalkylsulfonyl)imides, (fluoroalkylsulfonyl)(fluorosulfonyl)imides, polyvinyl alcohol, polyethylene oxides, divinyl benzene, metal salts with or without a polymer, and mixtures thereof. In exemplary embodiments, the ion exchange material comprises perfluorosulfonic acid (PFSA) polymers made by copolymerization of tetrafluoroethylene and perfluorosulfonyl vinyl ester with conversion into proton form.

As used herein, the term “coating composition” refers to liquid solutions or dispersions forming an electrode. The desired coating material is typically dissolved or suspended into a precursor solution or slurry (also referred as “ink”) and delivered onto the surface of the substrate through a precise coating head known as injection nozzle or a slot-die. The coating composition may form an anode or a cathode or both. The coating composition may be same or different for forming the anode or the cathode.

According to this disclosure, forming the first electrode on the first side of the substrate includes deposition a first coating composition on the first side of the substrate.

According to this disclosure, forming the second electrode on the second side of the substrate includes depositing a second coating composition on the second side of the substrate.

In embodiments, the first and second coating composition are the same or different.

In one embodiment, the first coating composition comprises a catalyst ink solution. Upon drying the composite of PEM and first coating composition, the solvent of the catalyst ink may dry to form a solid catalyst layer.

In one embodiment, the second coating composition comprises an anode ink solution. Upon drying the composite of PEM, cathode electrode and second coating composition, the solvent of the anode ink solution may dry to form a solid anode layer.

In another embodiment, the first and second coating composition comprises a catalyst and an ionomer.

There is no particular restriction on a catalyst employed, and any known catalyst can be used. Thus, the nature of the catalyst may vary widely. The catalyst may comprise noble metals, transition metals, or alloys thereof, and may be supported (optionally on a carbon support) or unsupported. Specific examples of catalytic materials include platinum, ruthenium, iridium, cobalt, and palladium, and are not limited to elemental metals. For example, the catalyst may also comprise iridium oxide, a platinum-ruthenium alloy, a platinum-iridium alloy, a platinum-cobalt alloy, etc. In some embodiments, the catalyst comprises a core shell catalyst, as described, for example, in US2016/0126560, the entirety of which is incorporated herein by reference. In some embodiments, the catalyst comprises a supported catalyst, which may comprise carbon as the support material. For example, in some embodiments, the catalyst comprises a supported platinum catalyst, such as platinum on carbon black.

In another embodiment, the ionomer is a proton-conducting polymer. In another embodiment, the proton-conducting polymer comprises perfluorosulfonic acid.

In another embodiment, the first and second coating composition comprising a solution or dispersion of an aqueous mixture. The aqueous mixture may comprise water, a water-soluble compound, a catalyst and an ionomer. The aqueous mixture optionally further comprises a water-soluble compound, optionally a water-soluble alcohol. Where the water-soluble compound comprises a water-soluble alcohol, the water-soluble alcohol optionally comprises isopropanol, tert-butanol or a glycol ether. If included in the mixture, the glycol ether optionally comprises dipropylene glycol (DPG) or propylene glycol methyl ether (PGME). The optional water-soluble compound may be present in the aqueous mixture in an amount less than 50 wt. %, optionally in an amount less than 25 wt. %, optionally in an amount less than 9 wt. %, or optionally in an amount less than 4 wt. %, based on a total weight of the ionomer and vehicle in the aqueous mixture. According to various embodiments, the aqueous mixture may contain organic compounds.

In another embodiment, the aqueous mixture comprising water, a water-insoluble component, a catalyst, and an ionomer, wherein the water-insoluble component comprises a water-insoluble alcohol, water-insoluble carboxylic acid or a combination thereof. In some embodiments, the water-insoluble component comprises a C5-C10 alcohol, a C5-C10 carboxylic acid, or a combination thereof. The water may be present in the aqueous mixture in an amount greater than about 10 wt. %, greater than about 50 wt. %, greater than about 70 wt. %, greater than about 80 wt. %, or greater than about 90 wt. %, based on a total weight of the ionomer and vehicle in the aqueous mixture. For example, the water may be present in the aqueous mixture in an amount from about 10 wt. % to about 99 wt. %, based on a total weight of the ionomer and vehicle in the aqueous mixture. The catalyst may be present in the aqueous mixture in an amount less than about 90 wt %, less than about 35 wt %, or less than about 9 wt. %, based on a total weight of the aqueous mixture. For example, the catalyst may be present in the aqueous mixture in an amount from 1 wt. % to 90 wt. %, from 1 wt. % to 42 wt. %, or from 3 wt. % to 30 wt. %, based on a total weight of the aqueous mixture.

The ionomer may be perfluorosulfonic acid (PFSA), and may be present in the aqueous mixture in an amount less than about 50 wt %, less than about 35 wt %, less than about 8 wt. %, or less than about 0.5 wt. %, based on a total weight of the ionomer and vehicle in the aqueous mixture. For example, the ionomer may be present in the aqueous mixture in an amount from 0.5 wt. % to 50 wt. %, based on a total weight of the ionomer and vehicle in the aqueous mixture.

In another embodiment, the first coating composition comprises an ink solution comprising at least 1% wt solids for forming the cathode. In another embodiment, the first coating composition comprises an ink solution comprising at least 2% wt solids for forming the cathode. In another embodiment, the first coating composition comprises an ink solution comprising at least 3% wt solids for forming the cathode. In another embodiment, the first coating composition comprises an ink solution comprising at least 4% wt solids for forming the cathode. In another embodiment, the first coating composition comprises an ink solution comprising at least 5% wt solids for forming the cathode. In another embodiment, the first coating composition comprises an ink solution comprising at least 6% wt solids for forming the cathode. In another embodiment, the first coating composition comprises an ink solution comprising at least 7% wt solids for forming the cathode. In another embodiment, the first coating composition comprises an ink solution comprising at least 8% wt solids for forming the cathode. In another embodiment, the first coating composition comprises an ink solution comprising at least 9% wt solids for forming the cathode. In another embodiment, the first coating composition comprises an ink solution comprising at least 10% wt solids for forming the cathode.

In another embodiment, the first coating composition comprising an ink solution or dispersion comprising at least 10 wt % of catalyst and ionomer for forming the cathode. The wt % of the above statements is based on 50% Pt/C ratio. The skilled person will adjust the wt % if another Pt/C ratio is chosen.

In another embodiment, the second coating composition comprises an ink solution comprising at least 1% wt solids for forming the anode. In another embodiment, the second coating composition comprises an ink solution comprising at least 2% wt solids for forming the anode. In another embodiment, the second coating composition comprises an ink solution comprising at least 3% wt solids for forming the anode. In another embodiment, the second coating composition comprises an ink solution comprising at least 4% wt solids for forming the anode. In another embodiment, the second coating composition comprises an ink solution comprising at least 5% wt solids for forming the anode. In another embodiment, the second coating composition comprises an ink solution comprising at least 6% wt solids for forming the anode. In another embodiment, the second coating composition comprises an ink solution comprising at least 7% wt solids for forming the anode. In another embodiment, the second coating composition comprises an ink solution comprising at least 8% wt solids for forming the anode. In another embodiment, the second coating composition comprises an ink solution comprising at least 9% wt solids for forming the anode. In another embodiment, the second coating composition comprises an ink solution comprising at least 10% wt solids for forming the anode.

In another embodiment, the second coating composition comprising a solution comprising at least 10 wt % of catalyst and ionomer for forming the anode.

The wt % of the above statements is based on 50% Pt/C ratio. The skilled person will adjust the wt % if another Pt/C ratio is chosen.

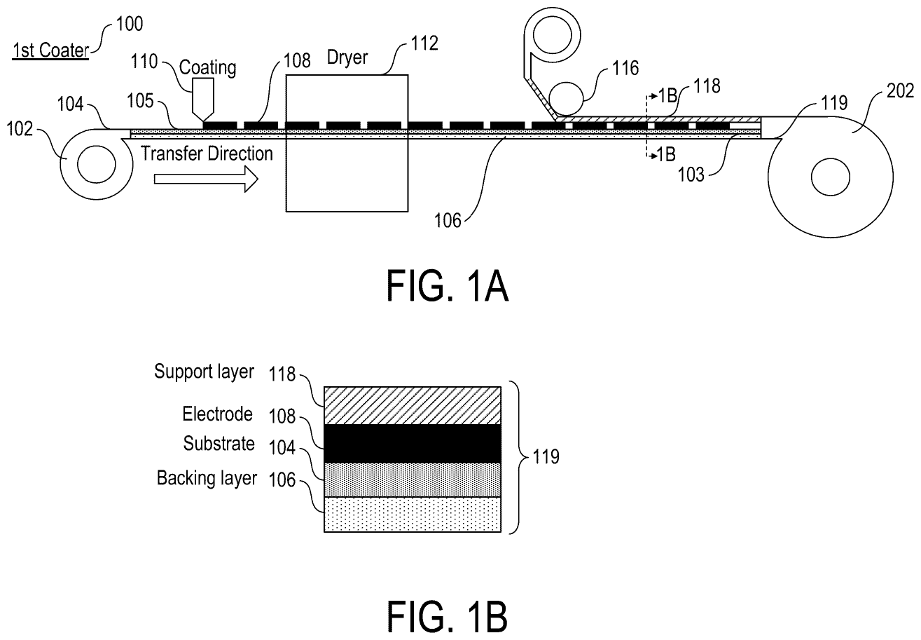

The method will now be described in relation to FIGS. 1 (a), (b) and 2 (a), (b).

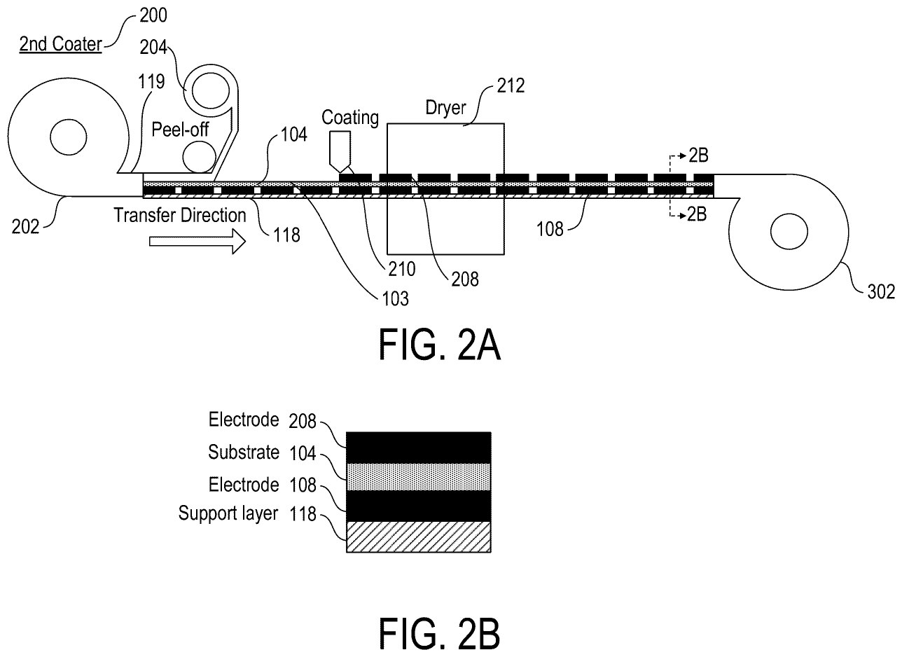

FIG. 1 (a) shows a first stage (1^{st} coater) 100 of the direct coating process of the present disclosure, and a second stage (2^{nd} coater) 200 of the direct coating process is shown in FIG. 2 (a). The 1st coater and the 2^{nd} coater can be the same or different coater.

In FIG. 1 (a) a first reel 102 is shown, wherein the first reel 102 comprises a substrate 104 roll with a backing layer 106. In FIG. 2 (a) a second reel 202 is shown which comprises composite 119 of FIG. 1(b) after the first coating step.

The method steps as shown in FIG. 1 (a) start with continuously unwinding the rolled substrate 104 including the backing layer 106 from the first reel 102. The substrate 104 is moving from first roll 104 to second roll 202 in a continuous manner. In one embodiment, the continuous movement might be supported by a moving table (not shown) with the backing layer 106 facing the table surface and with a first surface 105 of the substrate 104 facing the opposite.

The first surface 105 of the substrate 104 is then coated with a first coating composition forming the first electrode 108 via coating means 110. The coating means 110 may be a slot die. The slot die may be stationary or movable in relation to the moving substrate 104. As FIG. 1 (a) is showing the coating composition has been applied in an intermittent manner forming a discontinuous pattern. The substrate 104 and the newly formed wet first electrode 108 then passes through a dryer 112 where the wet first electrode 108 is dried and set for forming first electrode 108.

Following the drying step, a support layer 118 is applied on to the dried first electrode 108. The support layer 118 may be applied using conventional apparatus 116. The apparatus 116 delivers a continuous roll of the support layer 118, which is applied on to the dried first electrode 108. In one embodiment, the support layer 118 is applied by a lamination process using a hot roll and pressure. This forms a composite 119 comprising at this stage in the process, the backing layer 106, the substrate 104, the first electrode 108, and the support layer 118. The composite 119 is then moved towards and held on a second reel 202. The composite 119 is wound onto the second reel 202.

FIG. 1(b) shows the composite 119 and the order of the layers, starting from the inside of the reel 202 and extending outwards (in a radial direction) are 1) the backing layer 106, 2) the substrate 104, 3) the first electrode 108, and 4) the support layer 118.

In a next step, as shown in FIG. 2 (a) the rolled composite 119 is inverted so that a second electrode 208 may be formed on a second side 103 of the substrate 104.

FIG. 2 (a) shows the second stage 200 of the direct coating process. The second stage 200 of the direct coating process begins by unreeling the composite 119, which was formed during the first stage 100 of the process, from the second reel 202 and place it again on a moving table (not shown). As the composite 119 is released from the second reel 202, now the backing layer 106 is the uppermost layer, and the support layer 118 is the lowermost layer and is supporting the composite 119 as shown in FIG. 2 (a). This is the opposite order from that when the composite 119 was reeled onto the second reel 202.

The next step in the second stage 200 of the coating process is to remove the backing layer 106, to expose the second surface 103 of the substrate 104. This removal step may be carried out using conventional removal means 204. The removal means 204 may be a further reel or roll, which peels the backing layer 106 away from the remaining layers of the composite 119.

The exposed second surface 103 of the substrate 104, which is now available for depositing coating composition thereon, is coated with second coating composition by coating means 210 to form a second electrode 208. The coating means may be a slot die. The slot die may be stationary or movable in relation to the substrate 104. As FIG. 2 (a) is showing the second coating composition has been applied in an intermittent manner forming a discontinuous pattern.

The newly formed second wet electrode 208 then pass through the dryer 212, where the second wet electrode 208 is dried for forming the second electrode 208.

Following the completion of both the first and second stages of the process, the substrate 104 is now coated with electrodes 108, 208 on both surfaces of the substrate and comprises the support layer 118 on the bottom. The finished assembly provides the fuel cell component of the present disclosure and is then wound onto a third reel 302.

FIG. 2 (b) shows the order of the layers as they are wound onto the third reel 302 and are as follows, (in the direction from inside the reel to the outside), 1) the support layer 118, 2) the first electrode 108, 3) the substrate 104, and 4) the second electrode 208.

In the specific embodiment shown in FIGS. 1 and 2, the transfer direction is the same for both stages of the coating process, unreeling from a first reel 102 onto a second reel 202 as shown from left to right in the first stage 100 of the coating process 100; and unreeling from the second reel 202 and reeling onto the third reel 302 from left to right in the second coating process 200.

It should be understood that this is just one exemplary embodiment of a method according to the disclosure. There may be other finished embodiments of layered material, including a substrate and electrodes which are within the scope of the claimed disclosure.

There may also be Gas Diffusion Layers (GDLs) attached to the outer surface of each electrode. If GDLs are attached to both electrodes then the final assembly is considered a five-layer assembly, having the layers placed adjacent to each other as GDL-Anode-PEM-Cathode-GDL in the final assembly. According to various embodiments, the layers may be formed in any order, for example the PEM may be formed before the GDLs, the anode, or the cathode.

The coating process may be carried out continuously or discontinuously. The electrodes may be forming a continuous layer or may having an intermittent pattern. Thus, although the process has been described above in relation to an intermittent coating, it is to be understood that the process can also be carried out in a manner forming continuous electrode layers.

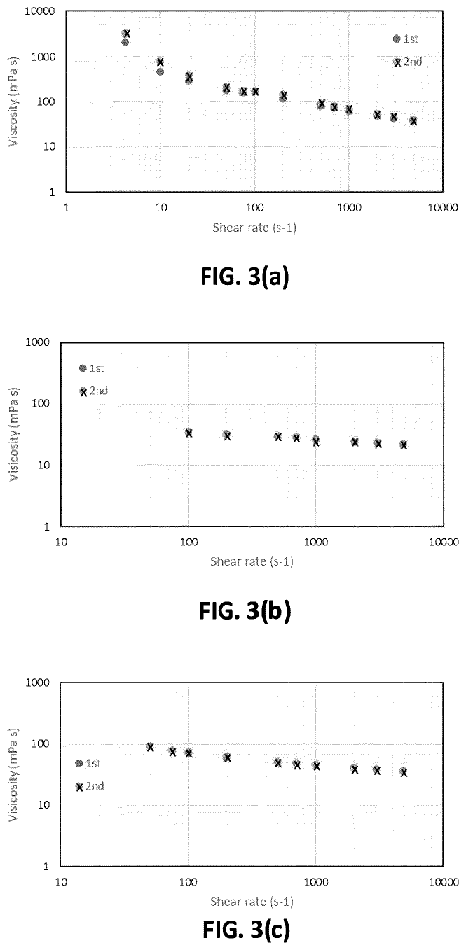

FIGS. 3 (a) to 3 (c) show different coating compositions and related properties which can be used in examples of this disclosure.

FIG. 3 (a) shows a graph of a first coating composition as an example of a cathode ink. FIG. 3 (b) shows a graph of a second coating composition as a first example of an anode ink and FIG. 3 (c) shows a graph of another second coating composition in the form of a second example anode ink. Each graph shows shear rate (s−1) on the x-axis, and Viscosity (mPa s) on the y-axis.

TABLE 1

| | | Cathode | | Anode | | | |
|---|---|---|---|---|---|---|---|
| Solid vol % | | 4.8 | | 5.2 | | 6.4 | |
| Wet thickness | | 92 um | | 20 um | | 16 um | |
| Viscosity | number | 1st | 2nd | 1^{st} | 2nd | 1st | 2nd |
| (mPa s) | 100 s⁻¹ | 164 | 170 | 35 | 35 | 71 | 74 |
| | 200 s⁻¹ | 115 | 144 | 32 | 31 | 60 | 63 |
| | 1,000 s⁻¹ | 60 | 68 | 27 | 26 | 46 | 46 |

Each graph shows the test results of two measurements (1^{st} and 2^{nd}) of the same ink. This was to guarantee the accuracy and repeatability of the tests.

FIG. 3 (a) shows an example of a cathode ink, with a wet coating thickness of 92 microns. The cathode ink of FIG. 3 (a) comprises solids including Perfluorosulfonic (PFSA) ionomer, (Pt on carbon) in an amount of 4.8 vol % in an aqueous composition of 47.6 vol % water and 47.6 vol % Propan-1-ol (also known as propanol or n-propyl alcohol (NPA)). The first anode ink of FIG. 3 (b) was applied with a wet coating thickness of 20 microns and comprises solids including Perfluorosulfonic (PFSA) ionomer, in an amount of 5.2 vol % in an aqueous composition of 47.4 vol % water and 47.4 vol % Propan-1-ol (also known as propanol or n-propyl alcohol (NPA)). The second anode ink of FIG. 3 (c) was applied with a wet coating thickness of 16 microns and comprises solids in an amount of 6.4 vol % in an aqueous composition of 46.8 vol % water and 46.8 vol % Propan-1-ol (also known as propanol or n-propyl alcohol (NPA)).

Table 1 above summarizes the values of the coating compositions of FIGS. 3 (a) to 3 (c).

Example: A PEM with a thickness of 18 microns was provided as substrate. The PEM comprises a backing layer on one surface of the PEM with a thickness of 50 microns. The PEM with the backing layer was coated following the process as described with respect to FIGS. 1a and 2a. A first coating composition as a cathode ink with a solid amount of 4.8 vol % is applied to the first surface of the PEM by a direct coating process using a slot die. After drying of the wet cathode coating, a support film has been laminated to the dried surface of the cathode layer. The support film comprises PET and has a thickness of 50 microns. The lamination of the support film uses a hot roll with a temperature of 160° C. and a pressure of 0.48 MPa. The resulting composite (as described with respect to FIG. 1(b) was turned so that the backing layer of the composite forms the top surface and the support film forms the bottom layer. A second coating process was done following the procedure as described in FIG. 2(a). A second coating composition as an anode ink with a solid amount of 5.2 vol % is applied to the second surface of the PEM (after taking the backing layer off) by a second direct coating process using a slot die. The applied wet anode layer was dried forming an assembly represented by FIG. 2 (b).

In forming a final MEA the support film has been removed. The final MEA (sample 1) has been inspected for surface wrinkles.

The MEA manufacturing process was repeated three times using different lamination conditions for attaching the support film.

Table 2 below illustrates the lamination conditions for the 4 samples:

TABLE 2

| MEA | Temperature | Pressure | Strength of |
|---|---|---|---|
| sample | ° C. | MPa | attachment (hand) |
| 1 | 160 | 0.48 | Ok |
| 2 | 160 | 0.42 | Ok |
| 3 | 160 | 0.37 | Weak |
| 4 | 180 | 0.42 | weak |

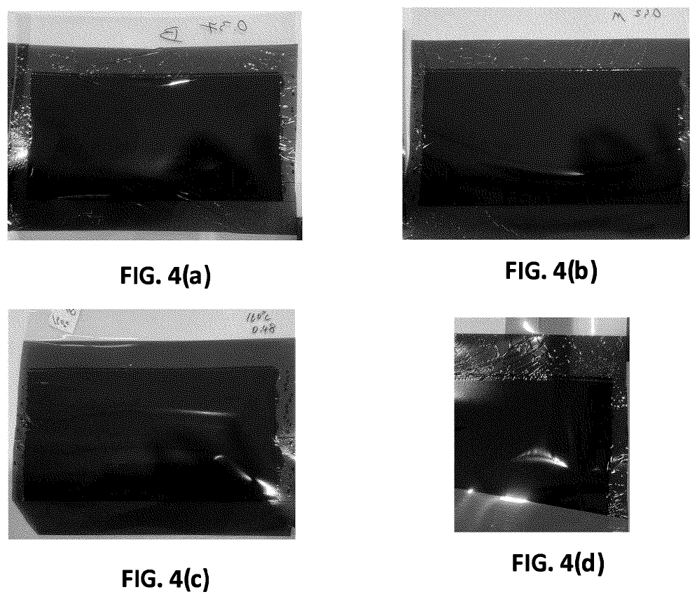

FIG. 4(a) represents MEA sample 3 and shows a high amount of wrinkles visible in the lighter frame around the MEA surface.

FIG. 4(b) represents MEA sample 2 and shows a surface of the MEA with a low amount of wrinkles.

FIG. 4(c) represents MEA sample 1 and shows a surface of the MEA sample and had the least amount of wrinkles which confirms the concept of using a support film in a direct coating process of thin PEMs.

FIG. 4(d) represents MEA sample 4 and shows a corner section of the MEA sample with a high amount of wrinkles.

The lamination conditions of MEA sample 1 and 2 seems to be ideal for manufacturing a MEA with a low amount of wrinkles.

While the invention has been described in detail, modifications within the spirit and scope of the invention will be readily apparent to the skilled artisan. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by the skilled artisan. Furthermore, the skilled artisan will appreciate that the foregoing description is by way of example only, and is not intended to limit the invention.

We claim:

1. A method of making a fuel cell component, the method comprising:
a. providing a substrate with a first side and a second side;
b. forming a first electrode on the first side of the substrate, wherein the forming includes depositing a first coating composition on the first side of the substrate;
c. applying a support layer onto the first electrode formed on the first side of the substrate;
d. inverting the substrate to make the second side of the substrate available for forming an electrode thereon;
e. forming a second electrode on the second side of the substrate wherein the forming includes depositing a second coating composition on the second side of the substrate.

2. The method of claim 1, wherein the substrate comprises a releasable backing layer on the second side of the substrate, and wherein step (d.) includes removing the backing layer so as to expose the second side of the substrate to make the second side of the substrate available for forming an electrode thereon.

3. The method of claim 1, wherein the depositing of the first and second coating composition on the first and second side of the substrate includes a coating process using a slot die.

4. The method of claim 1, wherein the first and/or second coating composition is deposited on to the substrate either continuously or intermittently, to form the first and second electrodes on the first and second sides of the substrate, respectively.

5. The method of claim 1 wherein the first or second electrode may be a cathode or anode.

6. The method of claim 1, wherein the first electrode on the first side of the substrate forms a cathode.

7. The method of claim 1, wherein the second electrode on the second side of the substrate forms an anode.

8. The method of claim 1, wherein the support layer comprises a PET film.

9. The method of claim 1, wherein the support layer comprises a gas diffusion layer.

10. The method of claim 1, wherein the support layer has a thickness of lower than 250 microns, lower than 200 microns, lower than 150 microns, lower than 100 microns, lower than 50 microns.

11. The method of claim 1, wherein the forming the first electrode on the first side of the substrate further comprises a step of drying the coating composition;
and the step of drying is carried out before the step of applying the support layer.

12. The method of claim 1, wherein the forming the second electrode on the second side of the substrate further comprises a step of drying the coating composition to form the electrode on the second side of the substrate.

13. The method of claim 1, wherein the first and/or second coating composition comprises a catalyst and an ionomer.

14. The method of claim 1, wherein the first and the second coating composition are the same or different and each independently comprises a supported catalyst, an ionomer and one or more solvents.

15. The method of claim 13, wherein the catalyst comprises a noble metal, a transition metal, or an alloy thereof.

16. The method of claim 14, wherein the ionomer is an ion exchange material, preferably, a proton-conducting polymer.

17. The method of claim 16, wherein the proton-conducting polymer comprises perfluorosulfonic acid.

18. The method of claim 1, wherein the first and second coating composition comprises an ink solution comprising at least 10 wt % of catalyst and ionomer.

19. The method of claim 1, wherein the substrate comprises a polymer electrolyte membrane (PEM).

20. The method of claim 1, wherein the fuel cell component comprises a membrane electrode assembly (MEA).

21. The method of claim 1, wherein the fuel cell component comprises a catalyst coated membrane (CCM).
